(19) United States
(12) Patent Application Publication
(10) Pub. No.: US 2013/0041534 A1
(43) Pub. Date: Feb. 14, 2013

(54) ECONOMY RUNNING SYSTEM FOR ELECTRIC VEHICLE AND CONTROL METHOD FOR THE SAME

(71) Applicant: Sang Joon Kim, Seoul (KR)

(72) Inventor: Sang Joon Kim, Seoul (KR)

(73) Assignee: HYUNDAI MOTOR COMPANY, Seoul (KR)

(21) Appl. No.: 13/324,555

(22) Filed: Dec. 13, 2011

(30) Foreign Application Priority Data
Aug. 11, 2011 (KR) 10-2011-0080322

(51) Int. Cl. B60L 15/20

(52) U.S. Cl. 701/22; 180/65.285; 903/902

(57) ABSTRACT

An economy running system for an electric vehicle and a control method therefor. The economy running system includes a central control unit, a motor control unit for receiving a signal from the central control unit and controlling the motor, an economy mode switch which selectively changes the driving mode of the electric vehicle between a normal mode and an economy mode, an accelerator position sensor which detects operation of an accelerator and transmits an accelerator position signal to the central control unit, a brake position sensor which detects operation of a brake and transmits a brake position signal to the central control unit, and a driving load determination unit which detects driving load information of the electric vehicle and transmits the information to the central control unit.

### CROSS-REFERENCE TO RELATED APPLICATION

This application claims priority to and the benefit of Korean Patent Application No. 10-2011-0080322 filed in the Korean Intellectual Property Office on Aug. 11, 2011, the entire contents of which are incorporated herein by reference.

### BACKGROUND OF THE INVENTION

(a) Field of the Invention

The present invention relates to an economy running system for an electric vehicle and a control method for the same.

(b) Description of the Related Art

Recently, due to the depletion of energy resources and environmental pollution, environmentally-friendly vehicles such as a hybrid vehicle and an electric vehicle are receiving attention.

An electric vehicle is a vehicle which is driven by electric power. A hybrid vehicle is combination of an internal combustion engine vehicle and an electric vehicle, wherein drawbacks associated with internal combustion engine vehicles and electric vehicles are addressed by the combination. A driver of a hybrid vehicle may switch driving modes of a hybrid vehicle between a combustion engine driving mode and an electric motor driving mode as required.

In a broad sense, an electric vehicle may include a hybrid vehicle. Thus, in this specification, an electric vehicle is understood as including a hybrid vehicle as well as a vehicle driven solely by electric power. In the electric vehicle industry, technical research has focused on improving travel distance and fuel (i.e. electricity) consumption. However, commercial application of these improvements is problematic.

An economy running system is a system which limits output changes of motor output according to a driver's intention (e.g. the driver's manipulation of the acceleration pedal and brake pedal) thereby improving fuel consumption. However, a conventional economy running system does not take into consideration a road slope and, thus, inevitably results in un-required waste of fuel (i.e. a battery). Further, with such systems, there may be a decline in the responsiveness to manipulation in high load driving conditions.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide an economy running system for an electric vehicle and a control method for the same having advantages of minimization of un-required waste of a battery for improving fuel consumption.

Also, the present invention has been made in an effort to provide an economy running system for an electric vehicle and a control method for the same having advantages of preventing excessive output changes in response to manipulation (e.g. manipulation of acceleration and deceleration pedals by a driver) and which enhances responsiveness to manipulation for improved drivability. Such systems can beneficially take into consideration other factors such as the slope of a road to further improve fuel efficiency.

In one aspect, an economy running system which is provided with at least one motor for driving the vehicle may include a central control unit, a motor control unit for receiving a signal from the central control unit and controlling the motor, an economy mode switch which selectively changes the driving mode of the electric vehicle to a normal mode or an economy mode, an accelerator position sensor which detects operation of an accelerator and transmits an accelerator position signal to the central control unit, a brake position sensor which detects operation of a brake and transmits a brake position signal to the central control unit, and a driving load determination unit which detects driving load information of the electric vehicle

According to an embodiment of the invention, the driving load information may include, for example, a road slope and speed of the motor.

According an embodiment of the invention, the central control unit may determine that the vehicle is accelerated according to the accelerator position signal in the economy mode, and may determine current acceleration torque according to the motor speed in acceleration, and required acceleration torque according to the accelerator position signal and the driving load information. The central control unit may further determine target acceleration torque according to the current acceleration torque and the required acceleration torque.

According to an embodiment of the invention, the central control unit may determine the target acceleration torque by approximating to a value of target acceleration torque of the normal mode when the road slope is upward, and the central control unit may reduce the target acceleration torque when the road slope is downward.

According to an embodiment of the invention, the central control unit may determine that the vehicle is in creep driving state according to the accelerator position signal and the brake position signal in the economy mode, and may determine current creep torque according to the motor speed, and required creep torque according to the brake position signal and the driving load information. The central control unit may further determine target creep torque according to the current creep torque and the required creep torque. According to an embodiment of the invention, the central control unit may reduce the target creep torque when the brake is operated.

According to an embodiment of the invention, the central control unit may determine that the target creep torque is “0” when the motor speed is “0” and the road slope is not inclined.

According to an embodiment of the invention, the central control unit may reduce the target creep torque when the road slope is downward regardless of operation of the brake.

According to an embodiment of the invention, the central control unit may determine that the vehicle is in a coasting regeneration driving state according to the accelerator position signal and the brake position signal in the economy mode, and may determine current regeneration torque according to the motor speed, and maximum coasting regeneration torque according to the driving load information. The central control unit may further determine target regeneration torque according to the current regeneration torque and the maximum coasting regeneration torque.

According to an embodiment of the invention, the central control unit may determine the target regeneration torque according to inclination value of the road slope.

In another aspect, the present invention provides a control method for an economy running system for an electric vehicle including a motor for driving the electric vehicle, a central control unit, a motor control unit, an economy mode switch, an accelerator position sensor, a brake position sensor and a driving load determination unit, wherein the method includes detecting accelerator position signal, brake position signal and driving load information using the accelerator position sensor, the brake position sensor and the driving load determination unit when the electric vehicle is driving in economy mode, and transmitting the signals to the central control unit; determining if the vehicle is in an acceleration driving state, in a creep driving state or in a coasting driving state; determining target torque of the motor according to the accelerator position signal, brake position signal and driving load information signal; and controlling the motor torque according to the determined target torque.

According to an embodiment of the invention, if the current driving state is an acceleration driving state, a target acceleration torque of the motor may be determined according to motor rotation speed, road slope and the accelerator position signal.

According to an embodiment of the invention, if the current driving state is a creep driving state, target creep torque of the motor may be determined according to motor rotation speed, road slope and the brake position signal.

According to an embodiment of the invention, if the current driving state is a coasting driving state, target regeneration torque may be determined according to motor rotation speed and road slope.

According to an embodiment of the present invention, un-required waste of a battery may be reduced when a vehicle is parked on an uphill slope or on a flatland/flat surface (wherein the terms flatland and flat surface may be used interchangeably, and as referred to herein are in accordance with the understood meaning in the related art, and generally refer to a generally flat region without a significant uphill or downhill slope) or when a vehicle is driving in a downhill slope.

According to an embodiment of the invention, in a coasting driving state in which an accelerator and a brake pedal are not operated, the charging amount of a battery by regenerative braking may be enhanced.

According to an embodiment of the invention, responsiveness to manipulation of an accelerator pedal may be improved by the present systems and methods.

### BRIEF DESCRIPTION OF THE DRAWINGS

FIG. 1 is a block diagram of an economy running system for an electric vehicle according to an exemplary embodiment of the present invention.

FIG. 2 is a block diagram for determining acceleration torque according to an exemplary embodiment of the present invention.

FIG. 3 is a block diagram for determining creep torque according to an exemplary embodiment of the present invention.

FIG. 4 is a block diagram for determining regeneration torque according to an exemplary embodiment of the present invention.

FIG. 5 is a flowchart of a control method for an economy running system for an electric vehicle according to an exemplary embodiment of the present invention.

### DESCRIPTION OF SYMBOLS

10: economy mode switch (ECO mode switch)

20: accelerator position sensor (APS)

30: brake position sensor (BPS)

40: driving load determination unit

50: central control unit

60: motor control unit (MCU)

70: motor

### DETAILED DESCRIPTION OF THE EMBODIMENTS

An exemplary embodiment of the present invention will hereinafter be described in detail with reference to the accompanying drawings.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

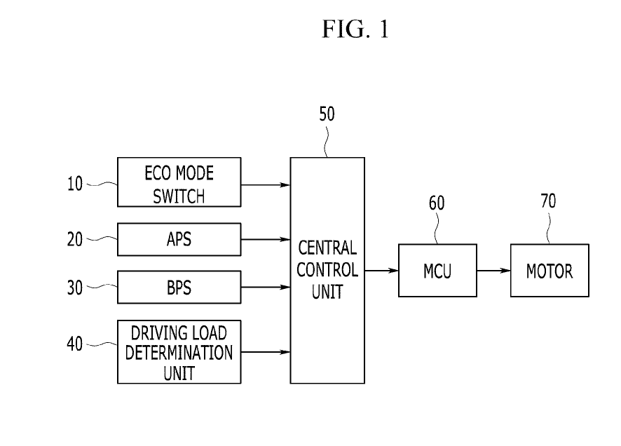

FIG. 1 is a block diagram of an economy running system for an electric vehicle according to an exemplary embodiment of the present invention.

As shown in FIG. 1, an economy running system for an electric vehicle includes an economy (ECO) mode switch 10, an accelerator position sensor (APS) 20, a brake position sensor (BPS) 30, a driving load determination unit 40, a central control unit 50, a motor control unit (MCU) 60 and a motor 70.

The economy mode switch 10 may be switched on or off to change the driving mode of a vehicle between economy mode and normal mode.

The accelerator position sensor 20 detects the position (i.e. angle at which the pedal is positioned in degrees) of an accelerator pedal (not shown) as manipulated by a driver, and transmits the detected accelerator position signal to the central control unit 50.

The brake position sensor 30 detects the position (i.e. angle at which the pedal is positioned in degrees) of a brake pedal (not shown) as manipulated by a driver, and transmits the detected brake position signal to the central control unit 50.

The driving load determination unit 40 detects driving load of a driving vehicle, and transmits the detected signal (information) to the central control unit 50. In some embodiments, the detected signal (information) of the driving load may include a road slope. In other embodiments, the road slope may be determined by the detected driving load information, wherein methods for determining the road slope using the detected driving load information are well-known and, thus, can be determined in accordance with any known method.

The central control unit 50 determines target torque of the motor 70 required according to driving conditions based on signals from the economy mode switch 10, the accelerator position sensor 20, the brake position sensor 30 and the driving load determination unit 40. The central control unit 50 then transmits the target torque signal to the motor control unit 60. In some embodiments, the central control unit 50 may be a hybrid control unit (HCU) if the vehicle is a hybrid vehicle.

The motor control unit 60 controls the motor 70 according to the target torque received from the central control unit 50. Also, the motor control unit 60 detects rotation speed and other parameters of the motor 70, and transmits the detected signal to the central control unit 50.

In an exemplary embodiment of the present invention, the torque control of the motor 70 according to driving conditions of a vehicle will be described as three parts. That is, driving state of a vehicle may be divided into an acceleration state, a creep driving state and a coasting state, and torque control of the motor 70 for each state is realized.

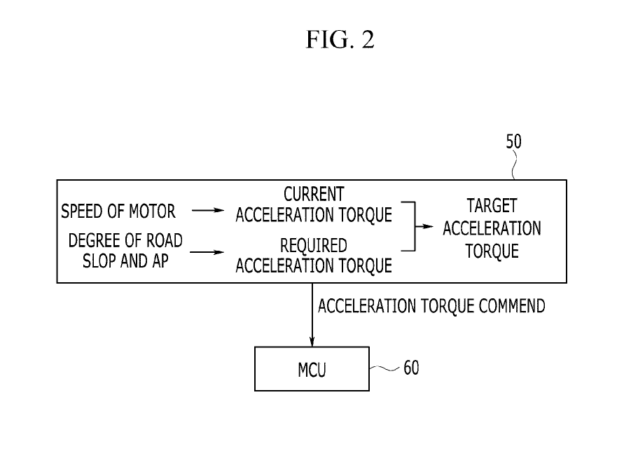

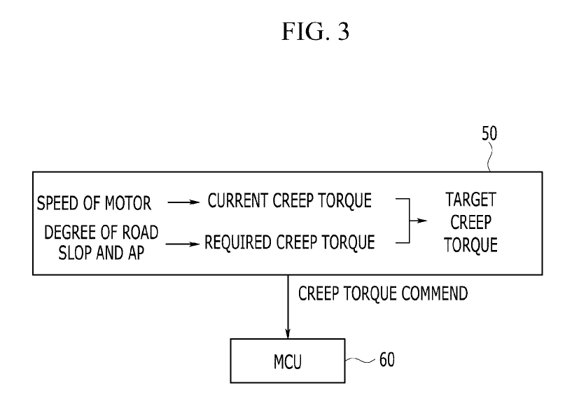

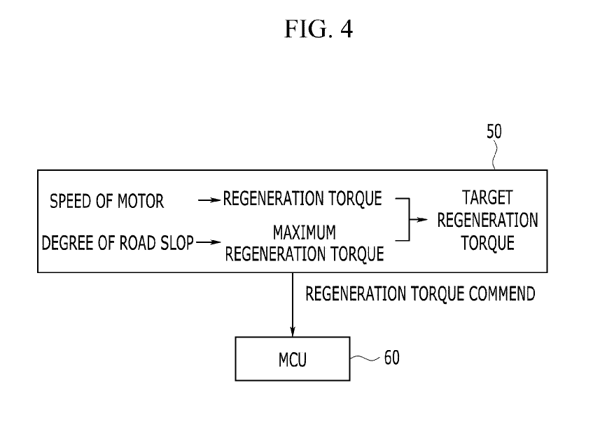

Hereinafter, referring to FIG. 2, FIG. 3 and FIG. 4, torque control of the motor 70 for each state will be described.

FIG. 2 is a block diagram for determining acceleration torque according to an exemplary embodiment of the present invention. In this case, acceleration torque means torque of the motor 70 according to the position (i.e. angle at which the pedal is positioned degrees) of an accelerator pedal as manipulated by a driver. That is, the acceleration torque is torque of the motor 70 when an accelerator pedal (not shown) is operated/manipulated.

As shown in FIG. 2, if a vehicle is in acceleration, the central control unit 50 determines target acceleration torque according to the detected information. Whether the vehicle is in acceleration may be determined according to operation of an accelerator (not shown). That is, if a driver pushes the accelerator pedal, it is determined that the vehicle is in an acceleration running state. The detected information may include, for example, speed of the motor 70, a road slope and the accelerator position (AP).

Referring to FIG. 1 and FIG. 2, the central control unit 50 determines current acceleration torque according to speed of the motor 70 received from the motor control unit 60. The current acceleration torque may be experimental data according to speed of the motor 70 in acceleration.

The central control unit 50 determines the acceleration torque required for driving the vehicle according to the accelerator position information received from the accelerator position sensor 20 and the road slope information received driving load determination unit 40. The required acceleration torque may be experimental data according to the road slope in acceleration and the accelerator position.

The central control unit 50 determines the target acceleration torque according to the current acceleration torque and the required acceleration torque. The central control unit 50 transmits an acceleration torque signal according to the determined target acceleration torque to the motor control unit 60 and, thus, the motor 70 is controlled.

As described above, the acceleration torque is a torque which is determined according to the speed of the motor 70 between maximum torque and minimum torque. Thus, the acceleration torque may vary according changes in the accelerator positions. Also, the target acceleration torque may vary depending on the road slope.

Further, according to embodiments of the present invention, general changes of the acceleration torque may further be determined by known methods based on the accelerator position changes, which is referred to herein as normal mode. The normal mode refers to a driving mode in which a driver does not choose the economy mode.

In the economy mode and when driving on a flat surface, if variation of the acceleration torques (variation of the target acceleration torque) according to the accelerator position variation is reduced below that of the normal mode, acceleration and deceleration of the vehicle may be insensitive. If acceleration and deceleration of the vehicle is insensitive in a range which does not influence drivability when driving on a flat surface, power consumption of a battery (not shown) may be reduced. The range which does not influence drivability during acceleration may be determined by a person of an ordinary skill in the art using known methods.

In uphill driving, if the variation of the acceleration torques (variation of the target acceleration torque) according to the accelerator position variation is similar to that of the normal mode, responsiveness to manipulation may be enhanced and, thus, drivability may be improved.

In downhill driving, if the variation of the acceleration torques (variation of the target acceleration torque) according to the accelerator position variation is reduced than that of the normal mode, power consumption of the battery may be reduced. In downhill driving, a range which does not influence drivability may be broader than the range which does not influence drivability on a flat surface, because acceleration of the vehicle is larger in downhill driving than that in flatland driving. The greater the degree of descent, the greater the acceleration of the vehicle, and thus variation of the target acceleration torque may be reduced in downhill driving. As such, the power consumption of the battery may be reduced in downhill driving.

FIG. 3 is a block diagram for determining creep torque according to an exemplary embodiment of the present invention. The creep torque means a torque of the motor 70 which is generated even when a driver does not push an accelerator pedal. That is, the creep torque may drive a vehicle or prevent backward movement of a vehicle in uphill driving without operation of the accelerator pedal, and a driver may control driving of a vehicle by manipulating a brake pedal (not shown).

As shown in FIG. 3, if a vehicle is in a creep driving state, the central control unit 50 determines target creep torque according to the detected information. The detected information includes, for example, the speed of the motor 70, the road slope and the position of brake pedal (BP: brake position). The creep running or the creep driving of a vehicle are well-known, and thus a detailed description will be omitted, and the general features thereof are in accordance with knowledge in the art. Further, a determination of whether the vehicle is in a creep running state may made using any known methods. Referring to FIG. 1 and FIG. 3, the central control unit 50 determines current creep torque according to speed of the motor 70 received from the motor control unit 60. The current creep torque may be experimental data according to speed of the motor 70 in a creep running state. The central control unit 50 determines a creep torque required for driving the vehicle according to the brake position information received from the brake position sensor 30 and the road slope information received from the driving load determination unit 40. The required creep torque may be experimental data according to road slope in the creep running state and the brake position.

The central control unit 50 determines target creep torque according to the current creep torque and the required creep torque. The central control unit 50 transmits an acceleration torque signal according to determined the target creep torque to the motor control unit 60 and, thus, the motor 70 is controlled.

As described above, the creep torque refers to the torque of the motor 70 which is generated even when a driver does not push an accelerator pedal. The creep torque may be reduced according to operation of the brake and angle (degrees) of road slope so that power consumption of the battery may be reduced.

If a driver manipulates the brake pedal to reduce the creep torque of the motor 70 in a range which does not influence drivability in flatland driving, power consumption of the battery may be reduced. Also, if the motor speed is reduced to “0”, then the target creep torque may be reduced to “0”. The range which does not influence drivability in the creep running state is well-known, and may thus be determined by a person of an ordinary skill in the art.

If a driver manipulates the brake pedal to reduce the creep torque of the motor 70 in a range which does not influence drivability in uphill driving, the power consumption of the battery may also be reduced. Also, if the vehicle stops, the target creep torque may be maintained at a minimum value to prevent the vehicle from moving backward according to the road slope and brake pedal position.

If the vehicle is driving in a downhill slope, the target creep torque may be reduced regardless of operation of the brake and the power consumption of the battery may, thus, also be reduced. In downhill driving, a range which does not influence drivability may be broader than the range which does not influence drivability in flatland driving, because acceleration of the vehicle is larger in downhill driving than in flatland driving. The greater the degree of descent the greater the acceleration of the vehicle, and thus variation of the target creep torque may be reduced in downhill driving. As such, the power consumption of the battery may be reduced in downhill driving.

FIG. 4 is a block diagram for determining regeneration torque according to an exemplary embodiment of the present invention. The regeneration torque refers to a torque of the motor 70 which charges a battery. That is, the regeneration torque is a torque of the motor 70 during regenerative braking. If the regeneration torque is generated in coasting running (coasting driving state), the battery may be charged.

As shown in FIG. 4, if a vehicle is in a coasting state, the central control unit 50 determines target regeneration torque according to the detected information. The detected information includes, for example, the speed of the motor 70 and the road slope. The coasting state is a driving state in which a brake and an accelerator are not operated. Coasting running or the coasting driving state are well-known and, thus, the general features thereof are in accordance with knowledge in the art.

Whether the vehicle is in a coasting driving state may be determined by operation of the brake and the accelerator, and can be realized with various known method.

Referring to FIG. 1 and FIG. 4, the central control unit 50 determines current regeneration torque according to the speed of the motor 70 received from the motor control unit 60. The current regeneration torque may be experimental data according to speed of the motor 70 in coasting running. The central control unit 50 determines maximum regeneration torque according to the road slope information received driving load determination unit 40. The maximum regeneration torque may be experimental data according to road slope in the coasting running.

The central control unit 50 determines target regeneration torque according to the current regeneration torque and the maximum regeneration torque. The central control unit 50 transmits a regeneration torque signal according to the determined target regeneration torque to the motor control unit 60 and, thus, controls the motor 70.

As described above, the target regeneration torque may vary according to the road slope, and the motor control unit 60 may control the regeneration torque.

If the regeneration torque of the motor 70 is increased in a range which does not influence drivability in flatland driving, charging amount of the battery may be increased. The range which does not influence drivability in the coasting running may be determined by any known methods.

If the regeneration torque is reduced during uphill driving, travel distance according to coasting running may be increased. That is, the target regeneration torque is reduced and the charging amount of the battery is reduced. If charging a battery is not efficient during the coasting running on an uphill slope, the travel distance according to coasting running may be increased rather than reducing the charging amount of the battery. As a result, the fuel consumption may be improved.

If the target regeneration torque is increased in a range which does not influence drivability during downhill driving, charging amount of the battery may be increased. During downhill driving, a range which does not influence drivability may be broader than the range which does not influence drivability in flatland driving because acceleration of the vehicle is larger in downhill driving than in flatland driving. As such, the charging amount of the battery may be increased further in downhill driving.

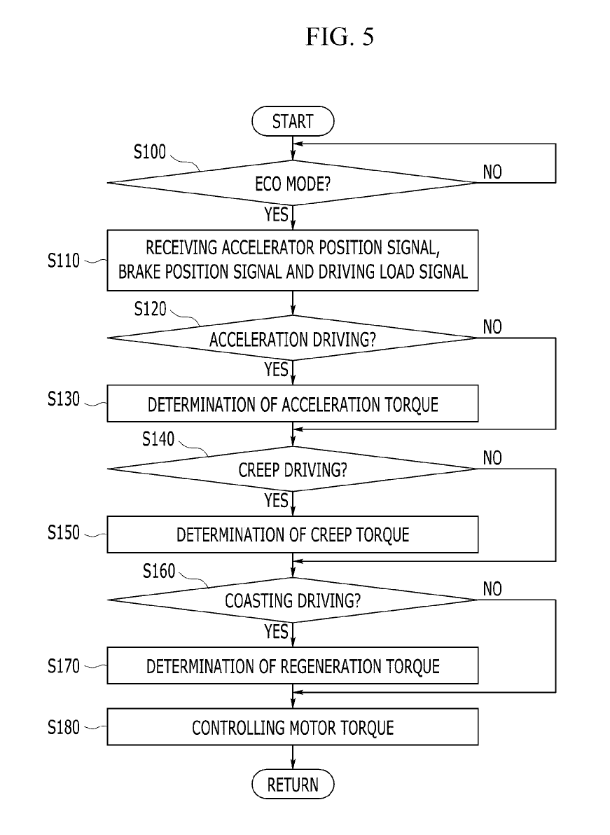

FIG. 5 is a flowchart of a control method for an economy running system for an electric vehicle according to an exemplary embodiment of the present invention.

As shown in FIG. 5, when a vehicle is being driven, the central control unit 50 detects whether the economy mode switch is on or off and determines whether the vehicle is in the economy mode S100.

If the vehicle is in the economy mode, the central control unit 50 receives an accelerator position signal, a brake position signal and a driving load signal from the accelerator position sensor 20, the brake position sensor 30 and the driving load determination unit 40 S110.

The central control unit 50 determines whether the vehicle is in an acceleration state based on the signal from the accelerator position sensor 20 S120.

If the vehicle is in an acceleration driving state, the central control unit 50 determines the target acceleration torque based on the current acceleration torque and the required acceleration torque S130. The current acceleration torque is determined according to the rotation speed of the motor 70, and the required acceleration torque is determined based on the accelerator pedal position signal and the degree of road slope signal received from the accelerator position sensor 20 and the driving load determination unit 40.

If the vehicle is not in the acceleration driving state, the central control unit 50 determines whether the vehicle is in a creep driving state according to a shift lever (not shown) position, the accelerator position and so on S140.

If the vehicle is in the creep driving state, the central control unit 50 determines the target creep torque based on the current creep torque and the required creep torque S150. The current creep torque is determined according to the rotation speed of the motor 70, and the required creep torque is determined according to the brake pedal position signal and the degree of road slope signal received from the brake position sensor 30 and the driving load determination unit 40.

If the vehicle is not in the creep driving state, the central control unit 50 determines whether the vehicle is in a coasting driving state according to the signals received from the accelerator position sensor 20 and the brake position sensor 30 S160.

If the vehicle is in the coasting driving state, the central control unit 50 determines the target regeneration torque based on the current regeneration torque and the maximum regeneration torque S170. The current regeneration torque is determined according to the rotation speed of the motor 70, and the maximum regeneration torque varies according to the degrees of the road slope signal received from the driving load determination unit 40.

The vehicle may be driven in the acceleration driving state, the creep driving state, or the coasting driving state, and the motor control unit 60 controls the torque of the motor 70 according to the determined target torque S180.

As described above, according to the exemplary embodiment of the present invention, the torque of the motor 70 is controlled in the acceleration driving state and the creep driving state taking into consideration the degrees of the road slope. As a result, unnecessary consumption of the battery may be reduced. Further, responsiveness to operation of the accelerator pedal in uphill driving may be improved.

In the coasting driving state, the regeneration torque of the motor 70 is controlled considering the degree of the road slope and, thus, the charging amount of the battery may be increased and fuel consumption may be improved.

Furthermore, the above described processes and methods may be performed by control logic embodied as computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server.

While this invention has been described in connection with what is presently considered to be practical exemplary embodiments, it is to be understood that the invention is not limited to the disclosed embodiments. On the contrary, it is intended to cover various modifications and equivalent arrangements included within the spirit and scope of the appended claims.

What is claimed is:

1. An economy running system for an electric vehicle, which is provided with at least one of motor for driving the vehicle, the economy running system comprising:
a central control unit;
a motor control unit configured to receive a signal from the central control unit and control the motor;
an economy mode switch configured to selectively change a driving mode of the electric vehicle between a normal mode and an economy mode;
an accelerator position sensor configured to detect operation of an accelerator and transmit an accelerator position signal to the central control unit;
a brake position sensor configured to detect operation of a brake and transmit a brake position signal to the central control unit; and
a driving load determination unit configured to detect driving load information of the electric vehicle and transmit the driving load information to the central control unit.

2. The economy running system of claim 1, wherein the driving load information comprises a road slope and speed of the motor.

3. The economy running system of claim 2, wherein the central control unit is configured to determine whether the vehicle is accelerated according to the accelerator position signal in the economy mode, to determine a current acceleration torque according to the motor speed in acceleration, and to determine a required acceleration torque according to the accelerator position signal and the driving load information, and wherein the central control unit is configured to determine a target acceleration torque according to the current acceleration torque and the required acceleration torque.

4. The economy running system of claim 3, wherein the central control unit is configured to determine the target acceleration torque by approximating to a target acceleration torque value in the normal mode when the road slope is upward, and the central control unit is configured to reduce the target acceleration torque when the road slope is downward.

5. The economy running system of claim 2, wherein the central control unit is configured to determine whether the vehicle is in a creep driving state according to the accelerator position signal and the brake position signal in the economy mode, to determine a current creep torque according to the motor speed, and to determine a required creep torque according to the brake position signal and the driving load information, and wherein the central control unit is configured to determine a target creep torque according to the current creep torque and the required creep torque.

6. The economy running system of claim 5, wherein the central control unit reduces the target creep torque when the brake is operated.

7. The economy running system of claim 6, wherein the central control unit is configured to determine the target creep torque as 0 when the motor speed is 0 and the road slope is not inclined.

8. The economy running system of claim 5, wherein the central control unit is configured to reduce the target creep torque when the road slope is downward regardless of operation of the brake.

9. The economy running system of claim 2, wherein the central control unit is configured to determine whether the vehicle is in a coasting regeneration driving state according to the accelerator position signal and the brake position signal in the economy mode, to determine a current regeneration torque according to the motor speed, and to determine a maximum coasting regeneration torque according to the driving load information, and wherein the central control unit is configured to determine a target regeneration torque according to the current regeneration torque and the maximum coasting regeneration torque.

10. The economy running system of claim 9, wherein the central control unit is configured to determine the target regeneration torque according to the road slope.

11. A control method for an economy running system for an electric vehicle including a motor for driving the electric vehicle, a central control unit, a motor control unit, an economy mode switch, an accelerator position sensor, a brake position sensor and a driving load determination unit, the control method comprising:
detecting an accelerator position signal, a brake position signal and driving load information using the accelerator position sensor, the brake position sensor and the driving load determination unit when the electric vehicle is driving in economy mode, and transmitting the signals to the central control unit;
determining if the vehicle is in an acceleration driving state, a creep driving state or a coasting driving state;
determining a target torque of the motor according to the accelerator position signal, brake position signal and driving load information; and
controlling the torque of the motor according to the determined target torque.

12. The control method of claim 11, wherein if a current driving state is an acceleration driving state, then a target acceleration torque of the motor is determined according to motor rotation speed, road slope and the accelerator position signal.

13. The control method of claim 11, wherein if a current driving state is a creep driving state, then a target creep torque of the motor is determined according to motor rotation speed, road slope and the brake position signal.

14. The control method of claim 11, wherein if a current driving state is a coasting driving state, then a target regeneration torque is determined according to motor rotation speed and road slope.

15. A computer readable medium containing program instructions executed by a controller, the computer readable medium comprising:
program instructions that detect and transmit an accelerator position signal, a brake position signal and driving load information of a vehicle to the controller;
program instructions that determine if the vehicle is in an acceleration driving state, a creep driving state or a coasting driving state;
program instructions that determine a target torque of a motor based on the accelerator position signal, the brake position signal and the driving load information; and
program instructions that control the torque of the motor according to the determined target torque.
